(19) United States
(12) Patent Application Publication
(10) Pub. No.: US 2022/0111694 A1
(43) Pub. Date: Apr. 14, 2022

(54) Shock absorber arrangement for a vehicle suspension and use of a lubricant for same

(71) Applicant: BASF Polyurethanes GmbH, Lemfoerde (DE)

(72) Inventors: Jae Hong LEE, Lemfoerde (DE); Ulrich Holwitt, Lemfoerde (DE); Frank Rittig, Ludwigshafen (DE)

(73) Assignee: BASF Polyurethanes GmbH, Lemfoerde (DE)

(21) Appl. No.: 17/429,639

(22) PCT Filed: Feb. 12, 2020
(86) PCT No.: PCT/EP2020/053595

§ 371 Date: Aug. 10, 2021

(30) Foreign Application Priority Data
Feb. 12, 2019 (EP) 19156778.3

(51) Int. Cl. B60G 15/06; F16N 15/00; C10M 103/00; C10M 103/02; C10M 107/00

(52) U.S. Cl. CPC B60G 15/06; F16N 15/00; C10M 103/00; C10M 103/02; C10M 107/00; C10N 2050/08; B60G 2204/4502; B60G 2206/41; B60G 2800/162; C10M 2201/1023; C10M 2201/0413; B60G 2202/32

(57) ABSTRACT

A shock absorber arrangement for a vehicle suspension contains a shock absorber having a damper cap and a piston rod, and a supplementary spring which is arranged on the piston rod opposite the shock absorber and has an outer surface facing the damper cap and an inner surface facing the piston rod, and is configured for damping the movement of the shock absorber in the direction of the piston rod on contact with the damper cap. The outer surface and/or the inner surface is at least partially coated with a lubricant.

The present invention relates to a shock absorber arrangement for a vehicle suspension, comprising a shock absorber which comprises a damper cap and a piston rod and a supplementary spring which is arranged on the piston rod opposite the shock absorber and has an outer surface facing the damper cap and an inner surface facing, the piston rod and is configured for damping the movement of the shock absorber in the direction of the piston rod on contact with the damper cap.

Shock absorber arrangements of the type indicated above are generally known. In the operation of a vehicle, a spring-in movement of the wheel suspension of the vehicle usually results in the shock absorber with its damper cap moving in the direction of the piston rod. In order to avoid damage to the shock absorber and possibly other components of the suspension on bottoming of the suspension of the vehicle, the shock absorber arrangements frequently have a supplementary spring which after a particular degree of compression of the suspension and corresponding degree of movement of the shock absorber comes into contact with the damper cap and dampens further compressive movement. Volume-compressible materials which bring about material damping by means of their geometry and/or volume compression are advantageously used for this purpose.

It has been observed that squeaking noises occur during operation of the abovementioned shock absorber arrangements, and although these do not impair the function of the shock absorber arrangement as such, they are perceived as annoying.

To manufacture the shaped bodies composed of microcellular polyurethane, the surface of the mold is frequently, even usually, pretreated with a mold release agent. Mold release agents based on oils, waxes, silicones and/or solid inorganic or organic additives, for example Teflon powder, or further products which reduce adhesion of the polyurethane to the mold surface are known to a person skilled in the art. It is known that particular mold release agents themselves can reduce or even prevent emissions of noise, especially some types of silicone-containing mold release agents. However, for reasons of protecting health and the environment, these variants are not preferred.

A residue of the mold release agent almost always remains on the surface of the molding in production of the shaped bodies. The type of residue can be influenced by the choice of the mold release agent, but the amount of residue depends on numerous factors during manufacture. These residues in places modify the emission of noise. Since the mold release agent is frequently an indispensable constituent of the manufacturing process, when reference is made in the following in connection with the invention to the shaped body composed of microcellular polyurethane this always refers both to the pure polyurethane shaped body and also the shaped body to the surface of which residues of a mold release agent still adhere. If reference is made in the following to a “dry” shaped body, this is intended to refer both to shaped bodies which are free of mold release agent and also to shaped bodies to which residues of mold release agents adhere.

To combat the above-described emissions of noise, attempts have been made in the past to use silicone-containing mold release agents in the manufacturing process. Owing to hazards to health which can arise from some silicon-containing compounds, this solution is however undesirable.

It was therefore an object of the invention to provide an alternative possibility for very largely decreasing noises in the operation of shock absorber arrangements. In particular, it was also an object of the invention to provide such a solution which does not pose hazards to health. The invention achieves the object of the invention in a shock absorber arrangement of the above-mentioned type by the outer surface and/or the inner surface of the supplementary spring being at least partially coated with a lubricant which is different from the damper fluid. In a preferred further development, the shock absorber has a damper fluid and the lubricant is different from the damper fluid.

In a particularly advantageous embodiment of the invention, the supplementary spring is made partly or entirely of a volume-compressible material.

The volume-compressible material (also: volume-compressible material of construction) is particularly preferably an elastomer based on cellular, in particular microcellular, polyisocyanate polyaddition products, in particular based on microcellular polyurethane elastomers and/or thermoplastic polyurethane, preferably comprising polyurea structures. Volume-compressible materials such as the abovementioned have the particular advantage that in comparison with other materials such as rubber they have extremely high capability for elastic change of shape together with high durability.

The polyisocyanate polyaddition products are preferably based on microcellular polyurethane elastomers, based on thermoplastic polyurethane or composed of combinations of these two materials which can optionally comprise polyurea structures.

Particular preference is given to microcellular polyurethane elastomers which, in a preferred embodiment, have a density in accordance with DIN 53420 of from 200 kg/m³ to 1100 kg/m³, preferably from 300 kg/m³ to 800 kg/m³.

The elastomers are preferably microcellular elastomers based on polyisocyanate polyaddition products, preferably having cells having a diameter of from 0.01 mm to 0.5 mm.

Elastomers based on polyisocyanate polyaddition products and production thereof are well known and widely described, for example in EP-A 62 835, EP-A 36 994, EP-A 250 969, DE-A 105 48 770 and DE-A 195 48 771.

The production process usually takes place via reaction of isocyanates with compounds reactive toward isocyanates.

The elastomers based on cellular polyisocyanate polyaddition products are usually produced in a mold in which the reactive starting components are reacted with one another. Molds that can be used here are generally conventional molds, for example metal molds, which by virtue of their shape ensure that the spring element has the inventive three-dimensional shape. In one embodiment, a foaming mold is used to produce the contour elements. In another embodiment, they are incorporated subsequently into the concentric main element. Another conceivable method uses parts manufactured from semifinished products. The manufacturing, process can by way of example use water-jet cutting.

The polyisocyanate polyaddition products can be produced by well-known processes, for example by using the following starting materials in a single- or two-stage process:

(a) isocyanate,

(b) compounds reactive toward isocyanates,

(c) water and optionally

(d) catalysts,

(e) blowing agents and/or

(f) auxiliaries and/or additives, for example polysiloxanes and/or fatty acid sulfonates.

The surface temperature of the inner wall of the mold is usually from 30° C. to 110° C., preferably from 50° C. to 100° C. Production of the moldings is advantageously carried out at an NCO/OH ratio of from 0.85 to 1.20, by mixing the heated starting components and introducing an amount thereof corresponding to the desired density of the molding into a heated mold which preferably closes tightly. The moldings have cured and can therefore be removed from the mold after from 5 minutes to 60 minutes. The amount of reaction mixture introduced into the mold is usually calculated so that the shaped bodies obtained have the density indicated above. The starting components are usually introduced with a temperature of from 15° C. to 120° C., preferably from 30° C. to 110° C., into the mold. The degrees of compaction for producing the shaped bodies are in the range from 1.1 to 8, preferably from 2 to 6. The cellular polyisocyanate polyaddition products are advantageously produced by the “one shot” process with the aid of high-pressure technology, low-pressure technology, or in particular reaction injection molding, technology (RIM), in open or preferably closed molds. Alternatively, a prepolymer process is used for the production of cellular polyisocyanate polyaddition products. The reaction is in particular carried out with compaction in a closed mold. Reaction injection molding technology is described by way of example by H. Piechota and H. Röhr in “Integralschaumstoffe” [Integral foams], Carl Hanser-Verlag, Munich, Vienna 1975; D. J. Prepelka and J. L. Wharton in Journal of Cellular Plastics, March/April 1975, pages 87-98 and U. Knipp in Journal of Cellular Plastics, March/April 1973, pages 76-84.

It has been recognized according to the invention that no or at least not very annoying emissions of noise occur in the case of a “dry” shock absorber arrangement and simultaneous use of a volume-compressible material such as microcellular polyurethane foam (see above). It has also been recognized that emissions of noise occur, for example, when damper fluid exits from the shock absorber and becomes distributed over the damper cap and/or the piston rod, even though the damper fluid, frequently a mineral oil, frequently intrinsically has usually friction-reducing properties. Proceeding therefrom, it has surprisingly been found that the undesirable noises can be significantly reduced by addition of a further lubricant which is different from the damper fluid and preferably likewise has a friction-reducing effect. The purported contradiction of the exit of the damper fluid itself having resulted in the annoying noises could be resolved in this way.

For example, emissions of noise in the shock absorber arrangement can also be caused by liquids other than damper fluid, for example other oils or water. Even particulate materials, for example dust, can lead to emissions of noise.

Even in the case of these causes, different from damper fluid, the addition of the lubricant leads to a reduction in undesirable noises.

However, the additional application of the lubricant, preferably in the form of a friction-reducing material, reliably prevents the emission of noises or at least reduces the occurrence thereof, so that the disruptive influence of the damper fluid is successfully compensated. These noises arise, for example, as a result of vibrations caused by the stick-slip effect.

Preferred embodiments of the invention are described below; a common aspect of each of these is that they bring about a reduction in or elimination of the stick-slip effect.

In a first preferred embodiment, the lubricant comprises or consists of one or more pulverulent inorganic materials having a crystalline fraction.

The pulverulent material preferably absorbs the damper fluid from the damper cap and/or the piston rod and also at least largely prevents the stick-slip effect due to its powder structure. Surprisingly, a relatively large reduction in noise is obtained even when the lubricant is not applied over the entire area of the outer surface and/or the inner surface but merely in regions.

In a preferred embodiment, the lubricant comprises or consists of a silicate, in particular a sheet silicate, particularly preferably selected from the group consisting of:

talc,

muscovite,

phlogopite,

apophyllite, or

carletonite.

In an alternative preferred embodiment, the lubricant comprises or consists of graphite. In a further preferred embodiment, the lubricant comprises or consists of a medium- or high-viscosity fluid. The fluid preferably has a kinematic viscosity of 270 mm²/s (cST) or more at 40′ C. Further preference is given to the fluid having a kinematic viscosity of 2000 mm²/s or more at 40° C. or a kinematic viscosity of 270 mm²/s or more at 100° C.

Further preference is given to the fluid having a kinematic viscosity of 16 000 mm²/s or more at 40° C. and a kinematic viscosity of 2000 mm²/s or more at 100° C.,

The fluid is preferably heat-resistant at temperatures in the range from 10° C. to at least 80° C.

The heat resistance mentioned in this context refers to a stability of the fluid in the sense of its technically reasonable use range. The limits of the use range are, for example, reached when chemical decomposition, oxidation or the like commence as a result of the temperature. Various fluids which have the desired kinematic viscosity are possible. Fluids having a low coefficient of friction are preferably provided.

The coefficient of friction is low relative to the coefficient of friction of a dry shaped body. It is measured, for example, by means of the mini-traction machine from PCS instruments, 78 Stanley Gardens, London, W3 7SZ, Great Britain. The measurement takes place on the steel-steel system. A low coefficient of friction for the purposes of the present invention is preferably in the region of 0.05 or below, preferably 0.02 or below, particularly preferably 0.01 or below.

The fluid particularly preferably comprises a resin or is formed thereby, preferably a polyether which has been produced using monofunctional or polyfunctional alcohols as starter with addition of epoxides. A high proportion of ethylene oxide is an advantage here. The fluid preferably comprises or consists of a polyalkylene glycol.

In further preferred embodiments, the fluid is produced using one or more additions of other alkylene epoxides, for example propylene oxide or butylene oxide. These lead to the target compound being liquid in the use range.

Ethylene glycol or short-chain liquid polyalkylene glycols, for example diethylene glycol, triethylene glycol or else polyethylene glycol 300 or polyethylene glycol 400 are likewise suitable as lubricant.

Copolymers based on ethylene oxide and propylene oxide are particularly suitable.

These polyalkylene glycols preferably comprise antioxidants as additive. They can also be deionized, neutralized, buffered and/or brought to a particular pH.

The application of the polyalkylene glycols can advantageously be carried out after prior dilution, e.g. in aqueous solution. Organic solvents such as short-chain alcohols, ketones, esters, amides or mixtures thereof, preferably mixtures of organic solvents with water, are also suitable. The fluid preferably comprises one or more further surface-active substances. If mention is made of a fluid in connection with the present invention, this should be taken to mean both purely liquid and also paste-like materials, as long as they have flow properties equivalent to fluids or similar to fluids.

The invention has been described above either with reference to the use of a particulate, i.e. pulverulent, material as lubricant or with reference to a fluid as lubricant. However, in preferred embodiments, the invention also relates to the use of a lubricant which comprises both pulverulent constituents according to one of the above-described preferred embodiments, and also fluidic constituents according to one of the above-described preferred embodiments. To avoid repetition, reference will in this respect be made to what has been said above in respect of the properties of these lubricant constituents.

In preferred embodiments, the lubricant has a pH in the range from 5 to 9, particularly preferably in the range from 6 to 8. Depending on the lubricant used, a pH buffer matched to the alkalinity of the lubricant is preferably added to the lubricant in order to attain the desired pH. The pH buffer preferably comprises a phosphate buffer. For the purposes of the invention, a phosphate buffer is a mixture comprising a hydrogen phosphate and a dihydrogen phosphate. As dihydrogen phosphate, the phosphate buffer particularly preferably comprises sodium and/or potassium dihydrogen phosphate, and as hydrogen phosphate it particularly preferably comprises disodium and/or dipotassium hydrogen phosphate.

The invention has, in a first aspect, been described in relation to the shock absorber arrangement of the invention. In a further aspect, the invention also provides for the use of a lubricant for reducing noise from a shock absorber arrangement. The invention achieves its underlying object in a shock absorber arrangement which comprises a shock absorber as per one of the above-described preferred embodiments, which comprises, in particular, a damper cap, a damper fluid and a piston rod and a supplementary spring arranged opposite the shock absorber, which spring has an outer surface facing the damper cap and an inner surface facing the piston rod and is configured for damping the movement of the shock absorber in the direction of the piston rod on contact with the damper cap, by the lubricant being different from the damper fluid and the outer surface and/or the inner surface being at least partially coated with the lubricant.

The lubricant is a silicone-free lubricant both in the shock absorber arrangement of the invention and also in the use according to the invention.

The use according to the invention utilizes the same advantages and preferred embodiments as the shock absorber arrangement of the invention. Preferred embodiments of the shock absorber arrangement are thus at the same time the preferred embodiments of the use according to the invention, and vice versa.

The use is, in particular, advantageously developed further by the lubricant

being a friction-reducing material and/or comprising or consisting of one or more pulverulent, in particular organic or inorganic, materials and/or

comprising or consisting of a silicate, in particular a sheet silicate, particularly preferably selected from the group consisting of:
talc,
muscovite,
phiogopite,
apophyllite,
carietonite, or
graphite.

As an alternative, the use according to the invention provides for the lubricant
to comprise or consist of a medium- or high-viscosity fluid, where the fluid preferably has
a kinematic viscosity of 270 mm²/s (cST) or more at 40° C.,
particularly preferably has a kinematic viscosity of 2000 mm²/s or more at 40° C. and a kinematic viscosity of 270 mm²/s or more at 100° C.,
very particularly preferably has a kinematic viscosity of 16000 mm²/s or more at 40° C. and a kinematic viscosity of 2000 mm²/s or more at 100° C.; and/or
comprises or consists of a compound having a low coefficient of friction, preferably a polyether which has been produced using monofunctional or polyfunctional alcohols as starter with addition of epoxides.

A high proportion of ethylene oxide is an advantage here. The fluid preferably comprises or consists of a polyalkylene glycol.

In further preferred embodiments, the fluid comprises one or more additions of other alkylene epoxides, for example propylene oxide or butylene oxide. These lead to the target compound being liquid in the use range.

Ethylene glycols or short-chain liquid polyalkylene glycols, for example diethylene triethylene glycol or polyethylene glycol 300 or polyethylene glycol 400, are likewise suitable as lubricant.

Copolymers based on ethylene oxide and propylene oxide are particularly suitable.

These polyalkylene glycols preferably comprise antioxidants as additive. Since they can also have, as a result of the production process, a pH differing from 7, they can be subsequently brought to particular pH values, preferably using, pH buffer systems.

The application of the polyalkylene glycols can advantageously be carried out after prior dilution, e,g. in aqueous solution, Organic solvents such as short-chain alcohols, ketones, esters, amides or mixtures thereof, preferably mixtures of organic solvents with water, are also suitable. The fluid preferably comprises one or more further surface-active substances. The coefficient of friction is low relative to the coefficient of friction of a dry shaped body. It is measured, for example, by means of the mini-traction machine from PCS instruments, 78 Stanley Gardens, London, W3 7SZ, Great Britain. The measurement takes place on the steel-steel system. A low coefficient of friction for the purposes of the present invention is preferably in the region of 0.05 or below, preferably 0.02 or below, particularly preferably 0.01 or below.

In the use according to the invention, the lubricant can be, for example, sprayed and/or brushed or painted onto the supplementary spring, or as an alternative or in addition be applied by dipping. The lubricant can also be applied a plurality of times in this way if necessary, or can be renewed after predetermined periods of time.

The invention will be illustrated below with reference to the accompanying figures with the aid of a preferred working example. The figures show

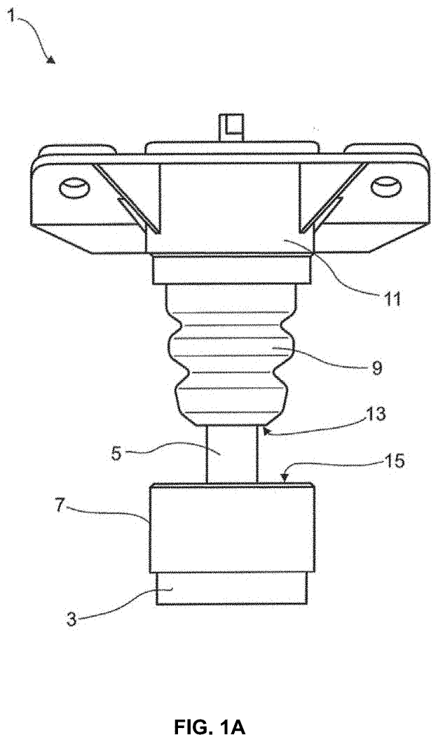

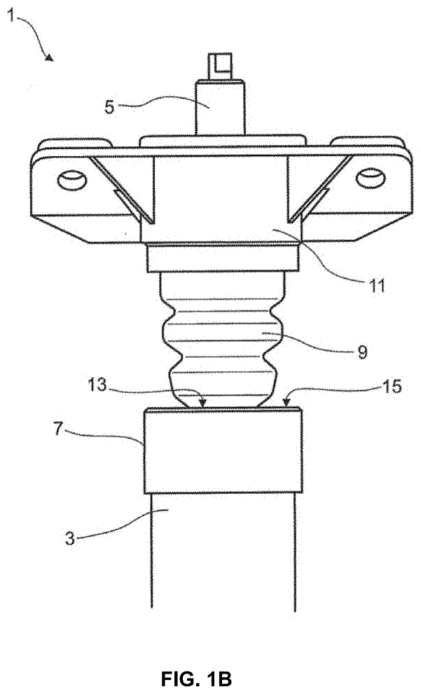

FIG. 1a, b a shock absorber arrangement according to a preferred working example in different operating states,

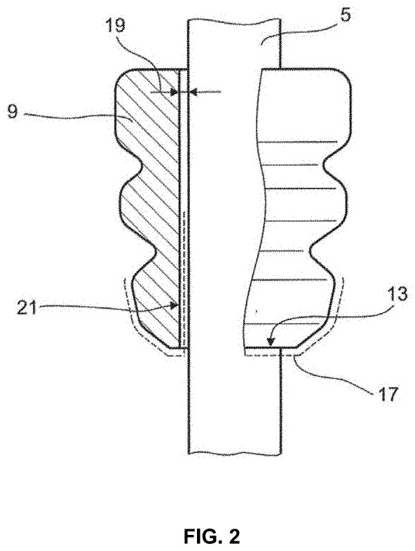

FIG. 2a detailed depiction of the shock absorber arrangement of FIG. 1a, b, and

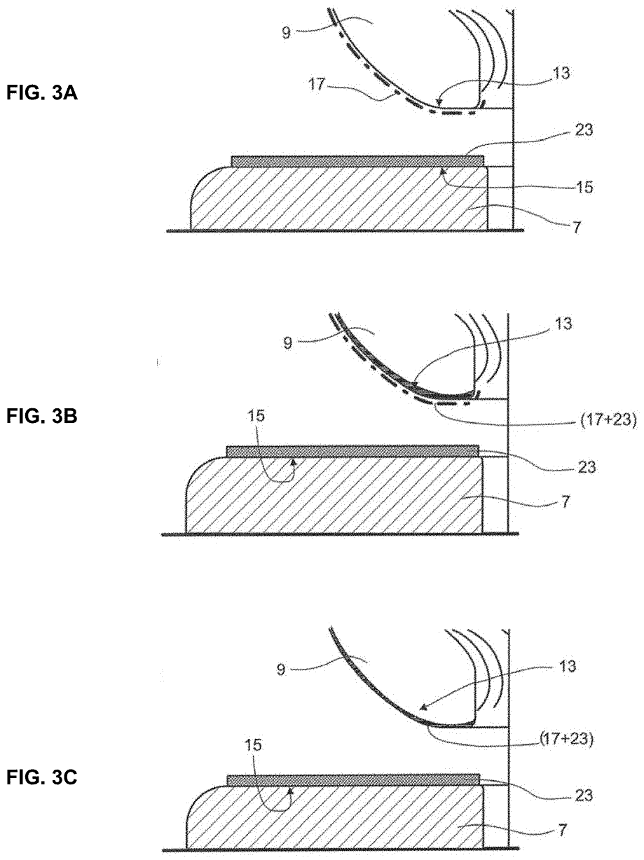

FIG. 3a-c further detailed depictions of the shock absorber arrangement according to FIGS. 1a, b and 2. in different operating states.

FIG. 1 shows a shock absorber arrangement 1. The shock absorber arrangement 1 comprises a shock absorber 3 having a damper cap 7 and a piston rod 5 which extends through the damper cap 7.

Opposite the damper cap 7, a supplementary spring 9 is arranged along the piston rod 5. The supplementary spring 9 is accommodated by a base 11.

The supplementary spring 9 has an outer surface 13 which faces an outer surface 15 of the damper cap 7.

During operation of the shock absorber arrangement 1, a state as shown in FIG. 1B can arise as a result of the movement of the damper. In this state, the outer surface 13 of the supplementary spring 9 is in contact with the end face 15 of the damper cap. If the shock absorber 3 continues to move, the supplementary spring 9 performs an evasive movement, as a result of which a relative movement of the outer surface 13 along the end face 15 occurs.

The working principle according to the invention, which then comes to bear, is explained in more detail in FIGS. 2 and 3a-c.

In FIG. 2, the supplementary spring 9 is firstly depicted in the partially sectioned state. The supplementary spring 9 is not compressed in the state shown in FIG. 2.

On the outer surface 13, the supplementary spring 9 is at least partially coated with a lubricant 17, which is particularly preferably a friction-reducing material such as talcum powder or another material of the above-described preferred embodiments. The lubricant 17 is, in the working example shown, additionally applied by way of example at least partially along an inner surface 21 of the supplementary spring 9, with the inner surface 21 facing the piston rod 5. A gap 19 is present between the inner surface 21 and the piston rod 5.

When compression of the supplementary spring occurs as indicated by way of example in FIG. 1b, the supplementary spring 9 expands in the radial direction, i.e. transverse to the piston rod 5, in an outward direction and an inward direction. The inner surface 21 then comes into contact with the piston rod 5. Here too, the lubricant 17 brings about the advantages according to the invention. Although the noise-reducing effect is not as pronounced as in the case of application of the lubricant 17 to the outer surface 13, it is nevertheless present and advantageous according to the invention.

The working example of FIG. 2 should be considered to be illustrative in so far as the exclusive coating of the inner surface 21 (at least partially) and also the exclusive coating of only the outer surface 13 (at least partially) are to be considered as separately encompassed preferred embodiments.

FIG. 3a-c show the behavior of the lubricant 17 in different operating states. In the interests of a simple depiction, only the coating on the outer surface 13 is shown here. The concept could, however, be carried over analogously to the behavior of a coated inner surface 21 relative to the piston rod 5 (cf. FIG. 2).

In FIG. 3a, a state in which the supplementary spring 9 has been coated with lubricant 17 on the outer surface 13 but has not yet come into contact with the damper cap 7 is firstly shown. Damper fluid 23 has collected on the end face 15 of the damper cap 7 as a result of operation of the shock absorber. If, proceeding from FIG. 3a, the supplementary spring 9 is brought into contact with the damper cap 7, the outer surface 13 takes up some of the damper fluid 23. Both damper fluid 23 and lubricant 17 which preferably but not necessarily partially or completely binds the damper fluid 23 if the lubricant comprises or consists of a pulverulent material are then present on the outer surface 13.

Due to the additional presence of the lubricant 17, an undesirable stick-slip effect is reliably decreased during continued operation.

FIG. 3c shows the state after prolonged operation or the state in the case of only very sparing wetting of the outer surface 13 with lubricant 17. The amount of damper fluid 23 and of lubricant 17 on the outer surface 13 is overall very much smaller than in the state shown in FIG. 3b. A significant noise reduction is nevertheless still achieved in the case of such an arrangement relative to a state in which damper fluid 23 but no additional lubricant 17 of a different nature than the damper fluid 23 is present on the outer surface 13.

It is a particular advantage of the invention that it can also be implemented retrospectively with little expense in existing damper systems. Since a partial and/or very thin coating of the supplementary spring 9 with the lubricant 17 suffices for reliable noise reduction, any envisaged maintenance intervals for renewing the coating can be made correspondingly long.

In a preferred embodiment, which envisages a pulverulent material as lubricant, the amount of the lubricant applied is in the region of 1 kg/m² or less, preferably in the region of 250 g/m² or less, particularly preferably in the range from 1 g/m² to 150 g/m².

In a further preferred embodiment, in which a polyalkylene glycol is used as lubricant, the amount of lubricant applied is preferably in the region of less than 500 g/m², preferably in the region of 100 g/m² or below, particularly preferably in the range from 0.1 g/m² to 40 g/m².

It has been found to be sufficient for many practical cases for, for example when using talcum powder as lubricant 17, an amount of only about 100 g/m² of talcum powder to be used, based on the surface area of a shaped polyurethane body. When using polyalkylene glycols, it has even been found that the desired effects are obtained even at amounts of about 15 g/m².

1-15. (canceled)

16. A shock absorber arrangement for a vehicle suspension, comprising:
a shock absorber which has a damper cap having an end face and has a piston rod, and
a supplementary spring which is arranged on the piston rod opposite the shock absorber and has an outer surface facing the damper cap and an inner surface facing the piston rod, and is configured for damping movement of the shock absorber in the direction of the piston rod on contact with the damper cap,
wherein the outer surface of the supplementary spring comes into contact with the end face of the damper cap, and the supplementary spring performs an evasive movement if the shock absorber continues to move, resulting in a relative movement of the outer surface along the end face,
wherein the supplementary spring expands in an inward and outward direction transverse to the piston rod on compression of the supplementary spring, whereupon the inner surface comes into contact with the piston rod, and
wherein the outer surface facing the damper cap and/or the inner surface facing the piston rod is at least partially coated with a lubricant.

17. The shock absorber arrangement according to claim 16, wherein the shock absorber comprises a damper fluid and the lubricant is different from the damper fluid.

18. The shock absorber arrangement according to claim 16, wherein the lubricant is a friction-reducing material.

19. The shock absorber arrangement according to claim 16, wherein the lubricant comprises one or more pulverulent organic and/or inorganic materials.

20. The shock absorber arrangement according to claim 19, wherein the lubricant comprises a silicate.

21. The shock absorber arrangement according to claim 19, wherein the lubricant comprises graphite.

22. The shock absorber arrangement according to claim 6, wherein the lubricant comprises a medium- or high-viscosity fluid.

23. The shock absorber arrangement according to claim 22, wherein the fluid has a kinematic viscosity of 270 mm²/s or more at 40° C.

24. The shock absorber arrangement according to claim 22, wherein the fluid comprises a resin.

25. The shock absorber arrangement according to claim 16, wherein hie lubricant comprises a water- and/or oil-repellent material.

26. The shock absorber arrangement according to claim 16, wherein the lubricant comprises pulverulent and fluidic constituents.

27. A method of reducing noise coming from a shock absorber arrangement of a vehicle suspension, comprising:
applying a lubricant to the shock absorber arrangement according to claim 16 to reduce noise.

28. The method according to claim 27 wherein the lubricant is a friction-reducing material; and/or
wherein the lubricant comprises one or more pulverulent materials, and/or comprises a silicate, and/or comprises graphite.

29. The method according to claim 28, wherein the lubricant comprises a medium- or high-viscosity fluid; and/or
wherein the lubricant comprises a resin.

30. The method according to claim 27, wherein the lubricant is a combination of solid and fluidic constituents.

31. The shock absorber arrangement according to claim 20, wherein the silicate is a sheet silicate.

32. The shock absorber arrangement according to claim 20, wherein the silicate is selected from the group consisting of talc, muscovite, phlogopite, apophyllite, and carletonite.

33. The shock absorber arrangement according to claim 23, wherein the fluid has a kinematic viscosity of 2000 mm²/s or more at 40° C. and a kinematic viscosity of 270 mm²/s or more at 100° C.

34. The shock absorber arrangement according to claim 23, wherein the fluid has a kinematic viscosity of 16000 mm²/s or more at 40° C. and a kinematic viscosity of 2000 mm²/s or more at 100° C.

35. The shock absorber arrangement according to claim 24, wherein the resin is a polyalkylene glycol.
